(19) United States
(12) Patent Application Publication
(10) Pub. No.: US 2015/0103033 A1
(43) Pub. Date: Apr. 16, 2015

(54) ELECTROMAGNETIC TOUCH-CONTROL SCREEN STRUCTURE

(71) Applicant: EverDisplay Optronics (Shanghai) Limited, Shanghai (CN)

(72) Inventors: Wenlung LU, Shanghai (CN); Wenchi LIN, Shanghai (CN); Huanhsun HSIEH, Shanghai (CN); Chiate CHO, Shanghai (CN); Chengpei HUANG, Shanghai (CN)

(73) Assignee: EverDisplay Optronics (Shanghai) Limited, Shanghai (CN)

(21) Appl. No.: 14/142,300

(22) Filed: Dec. 27, 2013

(30) Foreign Application Priority Data
Oct. 12, 2013 (CN) 201310476195.2

(51) Int. Cl. G06F 3/046

(52) U.S. Cl. CPC G06F 3/046
USPC 345/174

(57) ABSTRACT

An electromagnetic touch-control screen structure, comprising: a display panel; a touch-control plate over the display panel; an electromagnetic induction plate over the touch-control plate; and a cover lens attached on the electromagnetic induction plate. The electromagnetic touch-control screen of the disclosure, by deploying reasonable structure and manufacturing technique, stacks an electromagnetic induction plate with a touch-control plate, a cover lens and a display panel. Compared with existing manufacturing techniques, it can reduce one time of lamination operation, and dramatically decrease the thickness and weight of the electromagnetic structure, so that it can meet the need of lightness and thinness, for touch-control display equipments, like cellphone.

### CROSS-REFERENCE TO RELATED APPLICATIONS

This application claims the benefits of Chinese Patent Application No. 201310476195.2, filed on Oct. 12, 2013 in the State Intellectual Property Office of China, the disclosure of which is incorporated herein by reference in its entirety.

### TECHNICAL FIELD

The present disclosure relates in general to touch-control technology and, in particular, to a structure for electromagnetic touch-control screen.

### BACKGROUND

With the development of display technology and touch-control technology, various displays with touch-control function diversifying the functions of a display panel are emerging in the market, which not only display characters or images, but also have touch-control functions, so that users may perform input operations directly on the display, such as character input, handwriting or drawing and so on.

A finger control supported touch-control screen is widely used because of its operational ease. In order to achieve high precision and resolution, usually an additional electromagnetic induction plate is needed. Thus, the touch-control screen can provide accurate handwriting function and operational ease at the same time.

FIG. 1 is a schematic view showing the structure of touch-control screen in the related art. The manufacturing method for the touch-control screen is to produce an electromagnetic induction plate 2, a touch-control plate 3 and a display panel 4 respectively; and then assemble them accordingly. For example, the electromagnetic induction plate 2 is first combined with the display panel 4 and then is combined the touch-control plate 3, or the touch-control plate 3 is first combined with the display panel 4 and then is combined with the electromagnetic induction plate 2. At last, attach a flexible printed circuit (FPC) board 5 on the rear side of the electromagnetic induction plate 2 to support it. Then after attaching a cover lens 1 on the touch-control plate 3, a complete touch-control screen is formed.

Even though this kind of touch-control screen is featured with operational ease and high resolution, this solution can hardly satisfy the increasing need of lightness and thinness of cellphone, due to its adoption of an independent electromagnetic induction plate and FPC attached externally, which increases the thickness and weight.

The above information disclosed in this Background section is only for enhancement of understanding of the background of the disclosure and therefore it may contain information that does not form the prior art that is already known in this country to a person of ordinary skill in the art.

### SUMMARY

The present disclosure provides an electromagnetic touch-control screen structure.

Additional aspects and advantages will be set forth in part in the description which follows and, in part, will be apparent from the description, or may be learned by practice of the disclosure.

According to one aspect of the disclosure, there is provided an electromagnetic touch-control screen structure, comprising:

a display panel;

a touch-control plate over the display panel;

an electromagnetic induction plate over the touch-control plate; and

a cover lens attached on the electromagnetic induction plate.

According to some embodiments, the electromagnetic induction plate, the touch-control plate and the display panel are combined in a stacking way, and the cover lens is disposed on the electromagnetic induction plate in a lamination way.

According to some embodiments, the touch-control plate and the display panel are combined in a stacking way; the cover lens is attached on the electromagnetic induction plate in a stacking way; the electromagnetic induction plate is combined with the touch-control plate in a lamination way.

1. According to some embodiments, the cover lens, the electromagnetic induction plate and the touch-control plate are combined in a stacking way; the touch-control plate is combined with the display panel in a lamination way.

According to some embodiments, the cover lens is disposed on the electromagnetic induction plate by optical clear adhesive (OCA) or optical clear resin (OCR).

According to some embodiments, an isolation layer is provided for insulation between adjacent ones of the electromagnetic induction plate, the touch-control plate and the display panel.

According to some embodiments, an isolation layer is provided for insulation between the electromagnetic induction plate and the cover lens, and between the touch-control plate and the display panel.

According to some embodiments, an isolation layer is provided for insulation between the cover lens, the electromagnetic induction plate and the touch-control plate.

According to some embodiments, the electromagnetic touch-control screen is configured to cyclically process the capacitive signals from the touch-control plate and the electromagnetic signals from the electromagnetic induction plate according to time sequence.

According to another aspect of the disclosure, an electromagnetic touch-control screen structure is provided, comprising::

a display panel;

an electromagnetic induction plate over the display panel;

a touch-control plate over the electromagnetic induction plate; and,

a cover lens attached on the touch-control plate.

According to some embodiments, the touch-control plate, the electromagnetic induction plate and the display panel are combined in a stacking way; the cover lens is disposed on the touch-control plate in a lamination way.

According to some embodiments, the electromagnetic induction plate and the display panel are combined in a stacking way; the cover lens is disposed on the touch-control plate in a stacking way; the electromagnetic induction plate is combined with the touch-control plate in a lamination way.

According to some embodiments, the cover lens, the touch-control plate and the electromagnetic induction plate are combined in a stacking way; the electromagnetic induction plate is combined with the display panel in a lamination way.

### BRIEF DESCRIPTION OF THE DRAWINGS

The foregoing and other features and advantages of the disclosure will be apparent to those skilled in the art in view of the following detailed description, taken in conjunction with the accompanying drawings.

FIG. 1 illustrates a schematic diagram of the conventional touch-control screen structure.

FIG. 2a illustrates a schematic diagram of the touch-control screen structure according to one embodiment of the disclosure.

FIG. 2b illustrates a schematic diagram of the touch-control screen structure according to another embodiment of the disclosure.

FIG. 2c illustrates a schematic diagram of the touch-control screen structure according to still another embodiment of the disclosure.

FIG. 3a illustrates a schematic diagram of the touch-control screen structure according to still another embodiment of the disclosure.

FIG. 3b illustrates a schematic diagram of the touch-control screen structure according to still another embodiment of the disclosure.

FIG. 3c illustrates a schematic diagram of the touch-control screen structure according to still another embodiment of the disclosure.

### DETAILED DESCRIPTION

Exemplary embodiments of the disclosure will now be described more fully with reference to the accompanying drawings, in which exemplary embodiments are shown. Exemplary embodiments of the disclosure may, however, be embodied in many different forms and should not be construed as being limited to the embodiments set forth herein; rather, these embodiments are provided so that this disclosure will be thorough and complete, and will fully convey the concept of exemplary embodiments to those skilled in the art. In the drawings, the thicknesses of layers and regions are exaggerated for clarity. Like reference numerals in the drawings denote like elements, and thus their description will be omitted.

The described features, structures, or/and characteristics of the disclosure may be combined in any suitable manner in one or more embodiments. In the following description, numerous specific details are disclosed to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

The disclosure provides a structure and manufacturing method for an electromagnetic touch-control screen, which not only provides effective integration of a display panel, a touch-control plate and an electromagnetic induction plate but also further meets the requirement to be thin and lightweight.

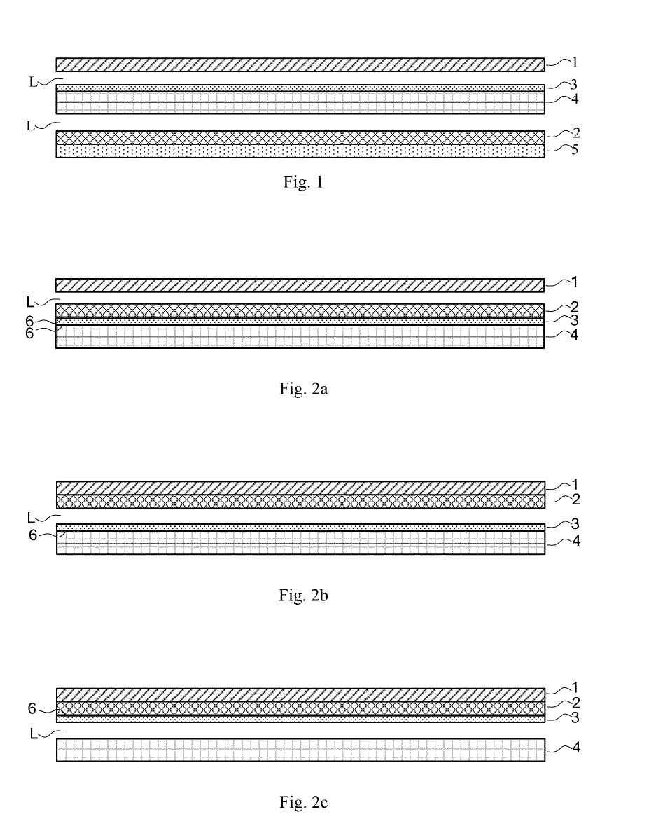

Referring to FIG. 2a, a schematic diagram of the touch-control screen structure according to one embodiment of the disclosure is shown. As shown in FIG. 2a, an electromagnetic induction plate 2, a touch-control plate 3 and a display panel 4 are stacked together, specifically, are superposed one on another layer by layer in an array manner. That is, the electromagnetic induction plate 2, the touch-control plate 3 and the display panel 4 are stacked layer by layer in an array, wherein the touch-control plate 3 is disposed on the upper surface of the display panel 4 and the electromagnetic induction plate 2 is disposed on the upper surface of the touch-control plate 3. An isolation layer 6 is disposed between adjacent ones of the electromagnetic induction plate 2, the touch-control plate 3 and the display panel 4 for insulation. Then a cover lens 1 is disposed on the upper surface of the electromagnetic induction plate 2 by lamination (shown as L in the figures), wherein lamination means bonding layers through optical clear adhesive (OCA) or optical clear resin (OCR). Thus, an electromagnetic touch-control screen is produced, which can be applied to various touch-control display devices.

The OCA or OCR may be used to attach the electromagnetic induction plate 2 and the cover lens 1. The display panel 4 consists of an Active Matrix Organic Light Emitting Diode (AMOLED) and a cover glass.

In the electromagnetic touch-control screen structure described above, the sequence of stacking or lamination of the layers can be flexibly arranged according to practical requirements. Referring to FIG. 2a, the electromagnetic touch-control screen structure can be integrated by firstly stacking the electromagnetic induction plate 2, the touch-control plate 3 and the display panel 4 together, and then attaching the electromagnetic induction plate 2 on the rear side of the cover lens 1 in a lamination way. Referring to FIG. 2b, the electromagnetic touch-control screen structure may alternatively be integrated by firstly attaching the electromagnetic induction plate 2 and the cover lens 1 to form a first portion, and then stacking the touch-control plate 3 and the display panel 4 together to form a second portion and then combining the first portion and the second portion in a lamination way. Or as shown in FIG. 2c, the electromagnetic touch-control screen structure may alternatively be integrated by firstly stacking the cover lens 1, the electromagnetic induction plate 2 and the touch-control plate 3 together to form a first portion, wherein OCA or OCR is used to bond the cover lens 1 and the electromagnetic induction plate 2. Then the first potion and the display panel 4 are combined in a lamination way to form the electromagnetic touch-control screen structure. The specific manufacturing method of the electromagnetic touch-control screen may be selected according to specific device characteristics of the touch-control plate 3, the electromagnetic induction plate 2 and the display panel 4.

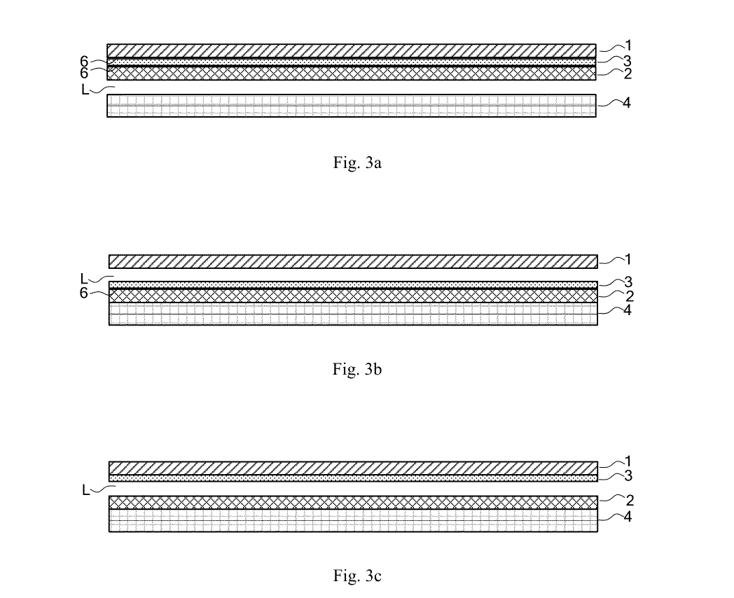

Referring to FIG. 3a, the electromagnetic touch-control screen structure are integrated by stacking the cover lens 1, the touch-control plate 3 and the electromagnetic induction plate 2 together, and then attaching the display panel 4 by lamination to the electromagnetic induction plate 2, The touch-control plate 3 is positioned under the cover lens 1 and the electromagnetic induction plate 2 is provided under the touch-control 3 and the touch-control plate 3 and the cover lens 1 are bonded with OCA or OCR. Additionally, the isolation layer 6 is disposed between adjacent ones of the cover lens 1, the touch-control plate 3, and the electromagnetic induction plate 2 for insulation.

Similarly, the sequence of stacking or lamination of the layers of this touch-control screen structure may also be flexibly arranged. As shown in FIG. 3a, the electromagnetic touch-control screen structure can be integrated by firstly stacking the cover lens 1, the touch-control plate 3 and the electromagnetic induction plate 2 together to form a first portion, and then combining the first portion with the display panel 4 in a lamination way. Or as shown in FIG. 3b, the electromagnetic touch-control screen structure can be integrated by firstly stacking the touch-control plate 3, the electromagnetic induction plate 2 and the display panel 4, and then bonding the cover lens 1 to the touch-control plate 3 in a lamination way. Or as shown in FIG. 3c, the touch-control plate 3 may be disposed under the cover lens 1 to form a first portion, and the electromagnetic induction plate 2 is attached on the display panel 4 to form a second portion, and then the electromagnetic touch-control screen structure may be formed by attaching the first portion to the second portion in a lamination way The specific manufacturing method for the electromagnetic touch-control screen may be selected according to specific device characteristics of the touch-control plate 3, the electromagnetic induction plate 2 and the display panel 4.

The above described electromagnetic touch-control screen structure of the disclosure has one or more of the following advantages.

1) Only once lamination operation is needed to produce the electromagnetic touch-control screen of the disclosure. On the contrary, in the related art, an extra lamination operation is needed to bond a FPC board to the electromagnetic touch-control screen.

2) Compared with the related art, the present disclosure has an extra isolation layer, yet omits a FPC board and accordingly the OCA or OCR by which the FPC board is combined to the electromagnetic induction board. Generally, the thickness of an isolation layer is less than 10 μm (micrometer), and those of a FPC board and OCA or OCR are about 120 mm (millimeter) and about 175 μm, respectively. Thus, the thickness of the electromagnetic touch-control screen of the disclosure is dramatically reduced. What's more, the electromagnetic touch-control screen of the disclosure is of much more lightweighted, since the isolation layer is of much more lightweighted than the FPC board.

Therefore, compared with related art, the electromagnetic touch-control screen of the disclosure is manufactured by stacking the electromagnetic induction plate, the touch-control plate, the cover lens and the display panel together, which reduces once lamination operation and dramatically decreases the thickness and weight of the screen structure. Thus, the touch-control screen of the disclosure is capable of meeting the need of lightness and thinness for touch-control display devices, such as cellphone.

In addition, in order to avoiding mutual interference between electromagnetic induction signal and touch-control signal, a signal processing method is adopted in which the capacitive signals from the touch-control plate 3 and the electromagnetic signals from the electromagnetic induction plate 2 are handled in turn. That is, according to the time sequence, the capacitive signals and the electromagnetic signals are cyclically processed: the capacitive signals are processed->the electromagnetic signals are processed->the capacitive signals are processed->the electromagnetic signals are processed. The order and duration of signal processing are not restricted, which can be adjusted according to specific requirements.

Exemplary embodiments have been specifically shown and described as above. It will be appreciated by those skilled in the art that the disclosure is not limited the disclosed embodiments; rather, all suitable modifications and equivalent which come within the spirit and scope of the appended claims are intended to fall within the scope of the disclosure.

What is claimed is:

1. An electromagnetic touch-control screen structure, comprising:
a display panel;
a touch-control plate over the display panel;
an electromagnetic induction plate over the touch-control plate; and
a cover lens attached on the electromagnetic induction plate.

2. The electromagnetic touch-control screen structure according to claim 1, wherein, the electromagnetic induction plate, the touch-control plate and the display panel are combined in a stacking way, and the cover lens is disposed on the electromagnetic induction plate in a lamination way.

3. The electromagnetic touch-control screen structure according to claim 1, wherein, the touch-control plate and the display panel are combined in a stacking way; the cover lens is attached on the electromagnetic induction plate in a stacking way; the electromagnetic induction plate is combined with the touch-control plate in a lamination way.

4. The electromagnetic touch-control screen structure according to claim 1, wherein, the cover lens, the electromagnetic induction plate and the touch-control plate are combined in a stacking way; the touch-control plate is combined with the display panel in a lamination way.

5. The electromagnetic touch-control screen structure according to claim 1, wherein, the cover lens is disposed on the electromagnetic induction plate by optical clear adhesive (OCA) or optical clear resin (OCR).

6. The electromagnetic touch-control screen structure according to claim 2, wherein, an isolation layer is provided for insulation between adjacent ones of the electromagnetic induction plate, the touch-control plate and the display panel.

7. The electromagnetic touch-control screen structure according to claim 3, wherein, an isolation layer is provided for insulation between the electromagnetic induction plate and the cover lens, and between the touch-control plate and the display panel.

8. The electromagnetic touch-control screen structure according to claim 4, wherein, an isolation layer is provided for insulation between the cover lens, the electromagnetic induction plate and the touch-control plate.

9. The electromagnetic touch-control screen structure according to claim 1, wherein, the electromagnetic touch-control screen is configured to cyclically process the capacitive signals from the touch-control plate and the electromagnetic signals from the electromagnetic induction plate according to time sequence.

10. An electromagnetic touch-control screen structure, comprising:
a display panel;
an electromagnetic induction plate over the display panel;
a touch-control plate over the electromagnetic induction plate; and,
a cover lens attached on the touch-control plate.

11. The electromagnetic touch-control screen structure according to claim 10, wherein, the touch-control plate, the electromagnetic induction plate and the display panel are combined in a stacking way; the cover lens is disposed on the touch-control plate in a lamination way.

12. The electromagnetic touch-control screen structure according to claim 10, wherein, the electromagnetic induction plate and the display panel are combined in a stacking way; the cover lens is disposed on the touch-control plate in a stacking way; the electromagnetic induction plate is combined with the touch-control plate in a lamination way.

13. The electromagnetic touch-control screen structure according to claim 10, wherein, the cover lens, the touch-control plate and the electromagnetic induction plate are combined in a stacking way; the electromagnetic induction plate is combined with the display panel in a lamination way.
